(19) United States
(12) Patent Application Publication
(10) Pub. No.: US 2006/0289474 A1
(43) Pub. Date: Dec. 28, 2006

(54) Tubular heater and method of manufacture

(76) Inventor: J. Evan Johnson, Minnetonka, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/471,024

(22) Filed: Jun. 20, 2006

Related U.S. Application Data
(63) Continuation-in-part of application No. 11/022,555, filed on Dec. 23, 2004, now Pat. No. 7,064,303.
(60) Provisional application No. 60/532,152, filed on Dec. 23, 2003.

(51) Int. Cl. H05B 3/44; H05B 3/50

(52) U.S. Cl. 219/544

(57) ABSTRACT

A tubular combination that is manually bendable to fit defined curve comprises an inner operational tubular element and an outer sheathing with defined slits therein. The slits are positioned and sized to control the bendibility of the combination by providing manually sensible radial bending limits as well as resistance to bending. The invention also includes the method of manufacturing and method of use of the tubular combination.

### CLAIM TO PRIORITY

This application is a continuation-in-part of U.S. patent application Ser. No. 11/022,555, filed Dec. 23, 2004, issuing Jun. 20, 2006 as U.S. Pat. No. 7,064,303, and claiming priority to U.S. Provisional Patent Application No. 60/532,152, filed Dec. 23, 2003. Both the provisional application and the parent application and issued patent are hereby incorporated by reference.

### FIELD OF THE INVENTION

The present invention relates to bendable tubular members with bending control or kink control. More specifically the invention relates to, for example, metal sheathing on a heater for use in a mold of an injection molding machine, cables, metal tubes and the like with anti-kinking sheathing and methods of manufacturing same.

### BACKGROUND OF THE INVENTION

Injection molding is used to manufacture a variety of plastic products. Molds used in these processes typically have several sections that when put together define a cavity in which molten plastic resin is injected.

To ensure that the molten plastic resin fills all of the details in the mold cavity, the molten plastic resin is preferably injected into the mold under pressure. The pressures that the molds are subjected to can be extreme and, as such, the mold components are often massive to support such pressures.

The resin pathways, “hot runners,” and the nozzles used to inject the molten plastic resin into the mold cavities have ancillary heating to properly maintain the molten plastic resin at a desired temperature. Often other areas of the molds need ancillary heat for controlling molding parameters, for example, controlling the rate of curing or hardening of the molten plastic. Johnson et al., U.S. Pat. No. 6,325,615, and Gellert, U.S. Pat. No. 5,148,594, both relate to systems for heating regions of molds. Because of the relatively hot temperatures and demanding environment at which the heating elements operate, they are subjected to degradation over extended use.

The heating elements are often placed in a meandering channel formed in the mold or mold plate where heat is desired. The heater will typically have a heat generation of approximately 50 watts per inch and the channel will typically be 0.300 to 0.500 inches in diameter. It is imperative that there be good thermal contact between the heater and the channel sidewall surfaces to provide the necessary heating to the mold components as well as to maximize the life of the heater. Ceramic paste or other material may then be utilized to fill the channel. Due to the diameter of these heaters they in the past have not been readily bendable. Attempts to manually bend conventional tubular heaters will generally result in kinks which ruins the heater. Conventionally, the heaters will be bent at the manufacturer or distributor using suitable jigs and powered equipment to the shape of the channel and then shipped to the end user. This adds problems if the bending is not totally accurate, increases the price of the heaters, and causes delays when a heater needs to be replaced. Ideally, the tubular heaters should be manually bendable for placement in the heaters by the end users. They could then be kept in stock and used as needed. Several manually bendable tubular heaters are illustrated in the prior art but they have various drawbacks.

Schmidt, U.S. Pat. No. 5,225,662, discloses a flexible heating element in which the heater core is covered with a plurality of beads. When the beads are placed in an adjacent relationship, the beads overlap each other to thereby protect the heater core from damage. This configuration does not present the possibility of a hermetically sealed tubular heater and can be difficult to manufacture.

Schwarzkopf, U.S. Pat. No. 6,250,911, describes an electrical heater for a mold in an injection molding machine. This patent indicates that the outer casing is formed from a highly ductile metal. The heating element and the insulating material that extends between the heating element and the casing are also flexible. This configuration for the electrical heater is stated to permit the heater to be bent by hand.

Schwarzkopf, U.S. Pat. No. 6,408,503 discloses a method of making an injection mold heating element. The method includes filling a region between a heating wire and an outer casing with a compressible insulating material. The casing is then radially inwardly compressed to form annular grooves.

Although the above heaters and methods of manufacturing them may work in certain applications, such designs may be improved upon to provide more heater to channel wall contact, better containment of the heater element and insulative material, easier and less expensive manufacture, manual or improved manual bendability, capability of bending tighter radii, and better reliability.

### SUMMARY OF THE INVENTION

A tubular combination that is manually bendable to fit defined curve comprises an inner operational tubular element and an outer sheathing with defined slits therein. The slits are positioned and sized to control the bendibility of the combination by providing manually sensible radial bending limits as well as resistance to kinking. The invention also includes the method of manufacturing and method of use of the tubular combination. A preferred embodiment includes a first row of slits on one side of the outer sheating, the slits having a gap open through the outer sheath. A further embodiment has an additional second row of slits on the opposite side of the outer sheath. The slits on the second row may also have a gap extending through the outer sheath. Alternate embodiments include an outer tubular sheath that has a multiplicity of slits extending in a circumferential direction through the outer sheathing and the outer sheathing swaged directly on the inner sheathing. A further embodiment includes the outer tubular sheathing formed from a multiplicity of individual rings, the outer sheath could be swaged directly on the inner sheath. A further embodiment includes a helical coil as the outer sheath.

A preferred embodiment is a tubular heater that is manually bendable to fit into a channel comprising a heating element positioned in an insulative material such as magnesium oxide and encased in a continuous inner nickel tubular sheathing. An outer sheathing, in a preferred embodiment, comprises a coil of copper with a nickel coating swaged such that the cross-section of a strand of the coil is generally rectangular. The invention also includes the method of manufacturing and method of use of the tubular heater. Alternate embodiments include an outer tubular sheath that has a multiplicity of slits extending in a circumferential direction through the outer sheathing and the outer sheathing swaged directly on the inner sheathing. For example, a tubing section as illustrated in FIG. 4a could have a plurality of slits cut through the radial thickness and each individual slit not extending entirely around the circumference. A further embodiment includes the outer tubular sheathing formed from a multiplicity of individual rings, the outer sheath could be swaged directly on the inner sheath.

Other preferred embodiments include tubular fluid lines, control lines with cables or wires therein, or other devices where control of the bending radius is desired.

An advantage of the present invention is the ability of the end user to manually bend the heating element to conform to unique mold channels on-site, allowing the heating element to be shipped directly from a distributor without the need for time-consuming, expensive custom bending to ensure a proper fit in the end-users application.

A further advantage of the present invention is the ability to insert heating elements into mold channels having smaller radius curves than was heretofore possible, allowing greater freedom in mold channel design.

Still another advantage of the present invention is the ability to tailor the allowable minimum bend radius of the assembly. The axial length of the rectangular cross-section is directly proportional to the bend radius that may be attained without deformation of the cross-section. Also, where circumferential slits are employed, the spacing between the slits is proportional to the bend radius obtainable. Thus, the invention allows one to establish a minimum bend radius that an interior element will be subjected to, thereby passively protecting the interior element from over bending.

### BRIEF DESCRIPTION OF THE DRAWINGS

FIG. 1 is a plan view of a tubular heater in accordance with the invention placed in a mold plate.

FIG. 2 is an elevational view of an end of a tubular heater in accordance with the invention with sections broken away.

FIG. 3 is a sectional taken at line 3-3 of FIG. 1.

FIG. 4 is perspective view of one possible embodiment of the outer sheath element of the present invention.

FIG. 4a is a cross-sectional view of FIG. 4.

FIG. 5 is a cross-sectional view of a further possible embodiment of the outer sheath element of the present invention.

FIG. 6 shows the effect of the coil cross-section on the bending radius of a helical coil.

FIG. 7 shows the effect of slit spacing on the bending radius of a circumferentially slitted sheath.

FIG. 8 shows the effect of slit spacing on the bending axis.

### DETAILED DESCRIPTION OF THE PREFERRED EMBODIMENTS

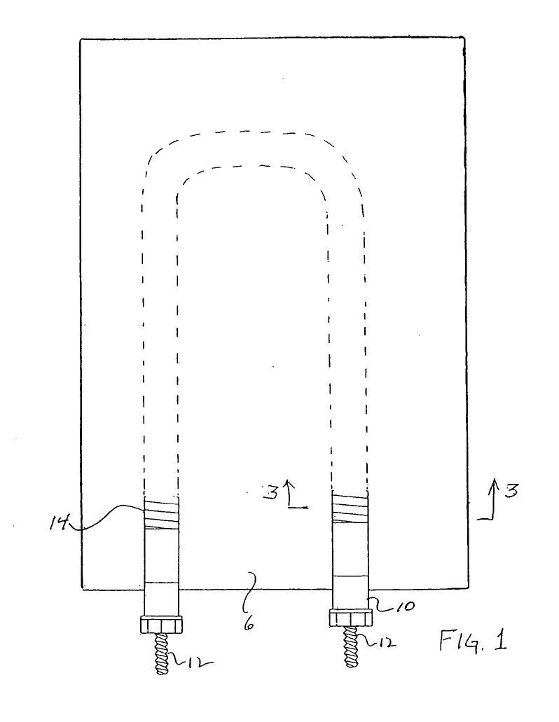

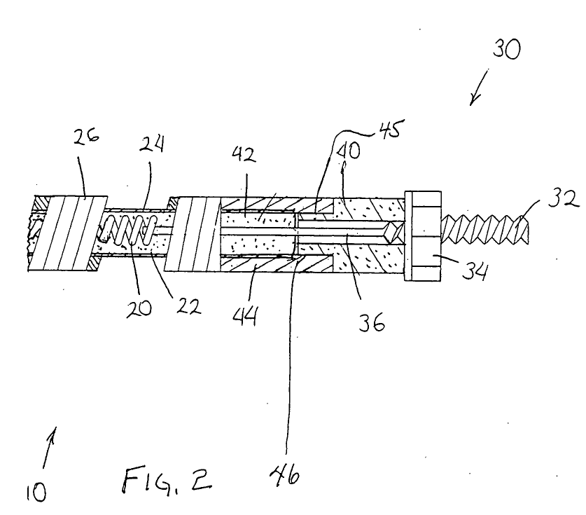

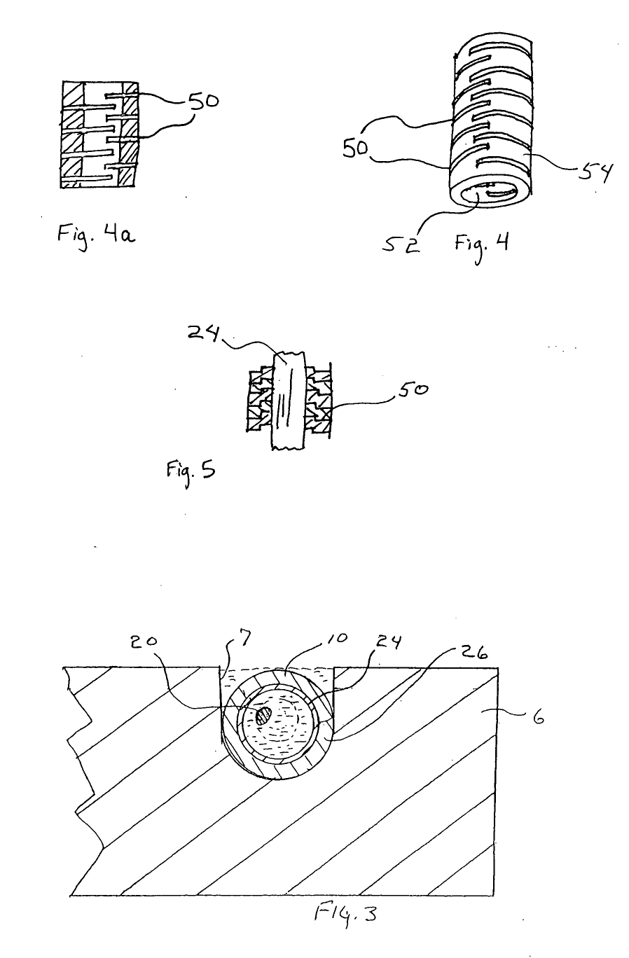

Referring to FIGS. 1, 2, and 3, the present invention is directed to a tubular heater 10 suitable for installation into channels 7 in molding plates or other components of an injection molding component. The heater may have other suitable applications.

The construction of the tubular heater 10 enables it to be manually bent into a desired configuration for use on the mold part. The tubular heater 10 prevents or inhibits entry of moisture into inner portions thereof, which are known to decrease the useful life of the mold heaters.

The heater 10 preferably is capable of handling current in the range of a few hundred watts to a few thousand watts depending on the need of the particular application. The heater 10 preferably has a current of about 50 watts per linear inch but may be, for example, be in the range of about 20 to about 200 watts per inch.

The heater 10 is typically formed with a length of between 0.5 foot and 6 feet depending on the size and shape of the mold on which the heater 10 is to be used.

The heater 10 generally includes a pair of end connectors 12, a body 14 with an exposed outer helical sheath 26. The body having a heating element 20 therein that is embedded or encased in insulative material 22. The heating element 20 used in conjunction with the present invention is preferably fabricated from nickel chromium wire. Preferably, the heating element 20 is in a coiled configuration. The insulation 22 is preferably magnesium oxide or other compositions that are known to a person of ordinary skill in the art.

A shell or inner sheath 24 preferably contains the heater element 20 and insulation 22. The inner sheath 24 is preferably fabricated from nickel that is used with a thickness of about 0.010 inches and preferably in the range of about 0.010 to about 0.025 inches. The inner sheath 24 preferably has an outer diameter of about 0.195 inches but may be in the range of about 0.140 to 0.350. Other sizes may also work in certain embodiments. The outer sheath 26 is preferably swaged on the inner sheath 24 and may comprise a single or a series of spring segments. The outer sheath 26 is preferably fabricated from nickel-plated copper. The outer swaged spring layer provides excellent heat conductivity from the inner sheath and heater element to the mold plate or other components in which the tubular heater 10 is mounted.

Because the outer spring layer 26 includes a plurality of windings when wrapped around the sheath 24, the outer sheath 26 also facilitates manual bending of the heater 10. When the outer spring layer 26 is placed over the shell 24, the heater 10 preferably has a diameter of about 0.315 inches but can be in the range of about 0.200 to about 0.500 inches. In a preferred embodiment where heater 10 has a diameter of about 0.315 inches, heater 10 is manually bendable to conform to radii in mold channels as small as about 0.25 inches.

One of the most important areas of conventional mold heaters is where the mold heater connects to a power supply because the relatively high level of power that passes through the mold heater results in degradation of the weakest portions of the mold heater such as often exists where the heating element intersects the end plug.

A connector 30 used with the tubular heater 10 preferably includes a threaded end connector 32 defining a bolt extending from the heater end.

A lead wire 36 extends between the heating element 20 and the bolt 32. The lead wire 36 is preferably fabricated from nickel. The lead wire 36 is preferably welded or brazed to the heating element 20. The lead wire 36 is preferably brazed to the bolt 32.

A high temperature ceramic preform 40 preferably extends over the lead wire 36. Crushed insulation 42 preferably magnesium oxide, may encase the lead wire 36 intermediate the ceramic perform 40 and the heater 10. A stainless steel cap 44 extends over the inner sheath and a reduced diameter end portion 45 of the ceramic preform 40. The ceramic preform may be secured in place with ceramic paste 46 and the nut 34 screwed on to the threaded portion.

A methodology of manufacturing the heater may be described as follows and includes variation hereto. As an initial step of forming the heater 10 of the present invention, a nickel plated round copper wire is formed into a coil on a form, and swaged on the form to provide a substantially cylindrical inner surface and outer surface. The swaged coil is then removed from the form and will be utilized as the outer sheath 26. This provides the coil with a generally rectangular cross section. The substantially cylindrical inner and outer surfaces are found to provide excellent heat conductivity between the inner and outer sheaths as well as between the outer sheath and the mold channel in which the heater is inserted.

A heating element 20 is encased with the insulation 22 and the inner sheath 24 with a pair of the lead wires 36 previously attached to the ends of the heater wire and extending out of the inner sheath. Encasing is preferably performed using swaging of the inner sheath with magnesium oxide and the heater element therein with the lead wires already brazed thereto. The encased heater in the inner sheath is sufficiently flexible to facilitate manual bending.

With the end of the heating element 20 preferably extending beyond the sheath 24, one of the connector ends is formed. The stainless steel cap 44 is attached to the inner sheath 24 preferably by swaging and/or by brazing.

Next, the outer spring sheath 26 is slid over the shell 24 until it abuts with the stainless steel cap 44. Sufficient swaged spring segments are applied to reach the predetermined length of the heater. The second end of the heater then has a stainless steel endcap placed thereon. Threaded end portions are attached to the lead wires. The end connectors are completed by inserting the ceramic preforms, preferably utilizing ceramic paste, and securing them with the nuts 34.

Once both of the connectors 30 are attached to the tubular heater 10, the completed heater 10 may be subjected to a swaging step. The heater may also be annealed at temperatures of about 1,800° F. If this annealing process is done, the annealed heater is subjected to a slow cool over at least a few hours.

The heater would preferably be pressfit within the channel of the mold component and suitable filler material, as is known in the art, may then fill the channel.

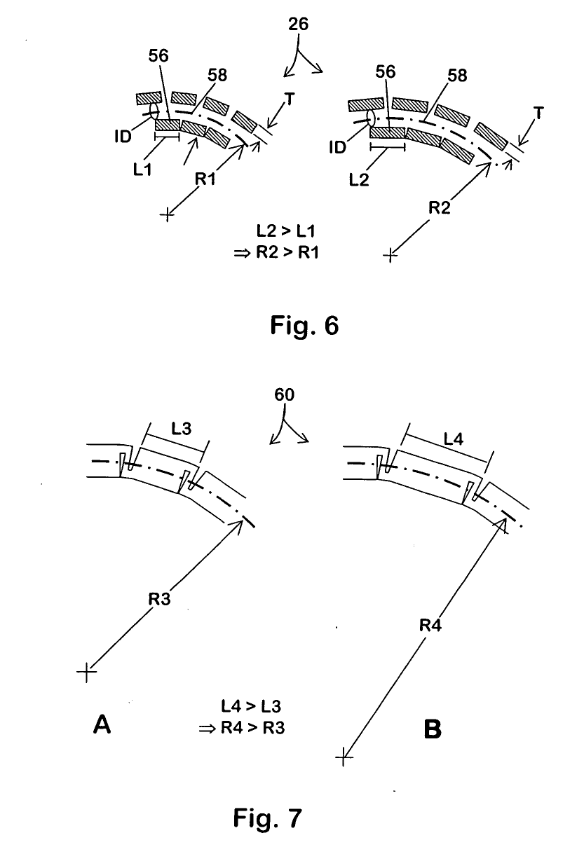

An alternative to swaging a coil of round wire to form an outer sheath 26 could include winding a rectangular shaped wire or bar flats, thus providing a substantially cylindrical inner surface 52 and outer surface 54. Such a coil may then be swaged onto inner sheath 24. Referring to FIG. 6, a side view of a helical outer sheath 26 is shown in cross-section. The cross-section comprises a series of rectangular cross-sections 56, each defined by an axial length L1 or L2 that runs parallel to the axis of the sheath 58, and a wall thickness T in a direction perpendicular to the sheath axis 58. Both embodiments shown in FIG. 6 have the same inner diameter ID and wall thickness T. Note that the minimum bend radii R1 or R2 of the sheath 26 is a function of the longitudinal length of the cross-section 56. A longitudinal length L2, which is longer than a longitudinal length L1, will result in a minimum bend radius R2 that is larger than a minimum bend radius R1 corresponding to the shorter longitudinal length L1.

A further alternative could be to provide the outer sheath 26 formed of a section of solid tubing, and then cutting slits 50 therein, said slits 50 preferably extending entirely through the radial thickness of the tubing wall but not entirely circumferentially around the tubing. The slits 50 may be open or closed, for example, if the outer slit tubing is swaged onto the inner sheath 24, the slits 50 may be closed. Referring to FIG. 7, the minimum bend radius of a slit tube 60 is a function of the distance between the slits. The FIG. 7 shows a distance L3 on an embodiment A that is less than the distance L4 in an alternate embodiment B. The resulting minimum bend radii of R3 and R4 of embodiments A and B, respectively, is such that R3 is less than R4. Hence, for a tube of given inner diameter ID and wall thickness T, a larger the spacing between slits will result in a greater minimum bend radius.

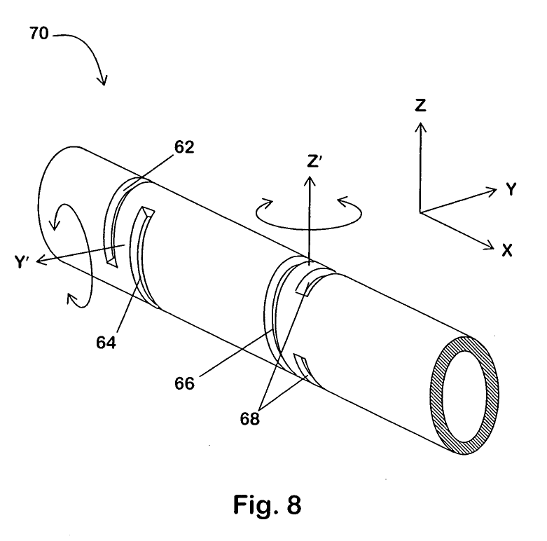

Referring to FIG. 8, an advantage of the slit tube 60 embodiment is that it can be utilized to allow bending only about a given axis, or can be configured to allow bending about a plurality of axes. The embodiment of FIG. 8 shows a segment 70 of a slit tube that has four slits 62, 64, 66 and 68 formed therein. A three-dimensional X-Y-Z coordinate system is shown for reference. The slits 62 and 64 combine to allow the segment 70 to be bent or rotated about a secondary axis Y′, while slits 66 and 68 combine to allow bending rotation about a secondary axis Z′. A multiplicity of slits oriented like slit 62 or slit 64 would combine to allow bending about the Y-axis, while a multiplicity of slits oriented like slit 66 or slit 68 would combine to allow bending about the Z-axis. One may choose to provide only slits that are oriented like slits 62 or 64, thereby allowing easy bending about the Y-axis while resisting bending about the Z-axis. Conversely, one could provide only slits oriented like slits 66 and 68, thereby allowing easy bending about the Z-axis while resisting bending about the Y-axis. Such sheathing may be marked on the exterior to show the correct bending direction or bendable portions. For example a strip may extend down the tubing as an indicator to indicate which side of the tubing should be the inside curvature of the correctly bent tubing.

It is noted that the present invention is not limited to tubular heater applications. The invention may also be utilized as a way to control the bend radius of a variety of operational cables and fluid flow tubing. Examples include the routing of sliding cables (e.g. brake or actuation cables), strain relief pig tails, fiber optic cables, or any other application where kinking, damage, or less than optimum performance may result from bending an interior element through a bending radius that is too small.

Accordingly, in another embodiment of the present invention, discrete segments of the outer sheath 26 may be provided only over certain sections of the inner sheath or element 24, with the remaining sections of the inner sheath 24 being exposed. The discrete sections may be appropriately positioned along the length of the inner sheath 24 to coincide with portions of the inner sheath or element 24 that require bending, in order to control the bending radius of the inner sheath. Such an embodiment is particularly suited for non-heater applications where radial contact for adequate heat transfer is not a factor, or where radiative coupling is the desired mode of heat transfer. Initial placement of the discrete sections may be accomplished by sliding the discrete section over the inner element 24 to a desired location on the inner element 24. The discrete sections may then be swaged or otherwise bonded to the inner sheath or element 24, or mounted to an external structure, or a combination thereof. Alternatively, discrete sections may be molded or otherwise integrally formed over portions of the inner element; this is particularly suited for mass production situations where the location of the controlled bend radius are known a priori. Of course, the outer sheath 26 need not be metallic, particularly in non-heat transfer applications. The outer sheath 26 may be made from a rubber, plastic or other polymer or fluoropolymer, a composite material, or any other material of suitable elasticity.

It is contemplated that features disclosed in this application, as well as those described in the above applications incorporated by reference, can be mixed and matched to suit particular circumstances. Various other modifications and changes will be apparent to those of ordinary skill. Patents previously mentioned, specifically U.S. Pat. Nos. 6,325,615, 5,148,594, 5,225,662, 6,250,911, and 6,408,503 are incorporated herein by reference.

What is claimed:

1. A bendable tubular heater for use in an injection molding component, the heater comprising
a flexible heating element wire having two ends;
two electrical connectors, each one in electrical connection to one of the two ends;
a continuous tubular first metallic sheath, said first metallic sheath having an outer diameter, an intermediate portion and two ends, the heating element wire extending through the intermediate portion of the metallic sheath;
insulative material surrounding and supporting the heating element wire within said first metallic sheath;
a second metallic sheath having an inner diameter and selected from the group consisting of a helically wound coil and tubing having at least one slit extending entirely thru the wall thickness, said inner diameter of said second metallic sheath being in contact with said outer diameter of said first metallic sheath along at least a portion of said inner sheath.

2. The bendable tubular heater of claim 1, wherein a series of said second metallic sheaths are located along said first metallic sheath.

3. The bendable tubular heater of claim 1, further comprising two end closures, one at each end of said first metallic sheath.

4. A bendable anti-kinking sheath assembly comprising
a tube section having an inner diameter, an axis and a wall;
a plurality of slits formed on at least one side of said tube, each of said slits extending through said wall of said tube section and defining a plane that is substantially perpendicular to said axis of said tube section; and
an inner element passing through said inner diameter of said tube section, said inner diameter of said tube section being dimensioned to fit said inner element.

5. The bendable anti-kinking sheath assembly of claim 4 wherein said inner element comprises a tubular electric heater.

6. The bendable anti-kinking sheath assembly of claim 4 wherein said inner element comprises a metallic tubular fluid flow line.

7. The bendable anti-kinking sheath assembly of claim 6 wherein said inner element comprises a hydraulic line.

8. The bendable anti-kinking sheath assembly of claim 6 wherein said inner element comprises a brake fluid line.
